(19) United States
(12) Patent Application Publication
(10) Pub. No.: US 2008/0276998 A1
(43) Pub. Date: Nov. 13, 2008

(54) Water Manifold System And Method

(75) Inventors: Christopher P. Boyher, Medina, OH (US); Scott L. Cuson, Litchfield, OH (US); Carl M. Mahabir, Streetsboro, OH (US); Christopher D. Zook, Akron, OH (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL ADVANCED MATERIALS, INC., Cleveland, OH (US)

(21) Appl. No.: 12/118,104

(22) Filed: May 9, 2008

Related U.S. Application Data
(60) Provisional application No. 60/917,328, filed on May 11, 2007.

(51) Int. Cl. F16L 41/00

(52) U.S. Cl. 137/561 A

(57) ABSTRACT

A system for distributing water within a building operates to distribute water from a pressurized water supply source to devices that receive water, such as faucets, toilets, showers, sprinklers, and hot water heating devices. The system includes at least one manifold which may be of unitary molded plastic construction and comprised of chlorinated polyvinyl chloride (CPVC). The manifold includes an entry port and a plurality of outlet ports which are also referred to as sockets. The sockets are configured to receive fitting inserts of various types that include water line connectors. The sockets are also configured to accept standard plastic water conduits therein in cemented relation. The water line connectors may include metallic connectors such as barbed fittings, which can be used to connect the manifold and crosslinked polyethylene (PEX) pipe in nonthreaded relation. Manifolds may be connected together to provide suitable distribution arrangements.

### CROSS REFERENCE TO RELATED APPLICATION

This application claims benefit pursuant to 35 U.S.C. § 119(e) of Provisional Application 60/917,328 filed May 11, 2007, the disclosure of which is incorporated by reference as if fully rewritten herein.

### TECHNICAL FIELD

This invention relates to water distribution systems and methods for distributing water to devices within a building. Exemplary embodiments relate to manifolds and systems which distribute potable water, hot water for heating, or water based fluids for other purposes, to multiple devices that receive water or fluids within a building. More particularly, exemplary embodiments relate to manifolds which are comprised of chlorinated polyvinyl chloride (CPVC) and which are suitable for connection through fitting inserts to multiple types of fluid conduits. Exemplary fluid conduits may of the type joined using solvent cement or other nonthreaded connections, and which are suitable for enclosure within the confines of a wall or floor structure.

### BACKGROUND ART

Proper and efficient distribution of water in buildings, particularly residential and commercial buildings, is important in modern society. Water is used in many areas of buildings for diverse functions such as drinking, washing, waste removal, cooking or other activities. In addition, many buildings rely on heated water circulated through radiators to keep the rooms at a comfortable temperature. In commercial buildings, water lines may extend to multiple fixtures, such as sprinkler heads for fire suppression. In some commercial buildings, water lines may extend to fixtures used in emergencies, such as eye wash stations and showers that are used by persons who have accidental exposure to harmful chemicals.

Conventionally, pressurized water is distributed from a source through main distribution lines and branch lines to each device which receives water. This is generally done with copper piping and fittings sweat-soldered in place. Alternatively, some water distribution systems used in buildings include CPVC pipe and fittings that can be solvent-cemented in operatively fixed connection. Often, copper or CPVC systems are installed in ways that are not readily expanded or reconfigured to accommodate additional water lines or changes to the water distribution system.

In recent years, molded polysulfone (PSU) and polyphenylsulfone (PPSIJ) water manifolds have been manufactured to provide branching points for the distribution of water within a building. These types of manifolds are costly, and generally complex. It is common for such manifolds to be made up of multiple joined pieces that are sealed with O-rings or other sealing devices. Further, such manifolds are generally connected to water lines through threaded fittings or other threaded-type connectors. In addition, such manifolds are permanently assembled at the factory, and are not readily expanded or modified in the field. A further drawback of such manifolds is that they are not compatible with solvent cements which are commonly used in construction for plastic pipe connections, particularly acrylonitrile-butadiene-styrene copolymer (ABS) piping or other materials that are used for wastewater connections. In addition, the threaded connectors used by such manifolds are generally not suitable for enclosure within a wall or floor of a building structure. This limits the areas and situations in which such manifolds can be used.

### OBJECTS OF EXEMPLARY EMBODIMENTS

Benefits may be achieved by providing manifolds and water distribution systems which are less complex, which can be configured to employ nonthreaded connections where required, are easily installed in a building, and are more readily expanded as the need may arise.

It is an object of exemplary embodiments to provide water manifolds for use in water distribution systems within buildings.

It is a further object of exemplary embodiments to provide versatile water manifolds for use in systems that are modular and suitable for in-place expansion and reconfiguration of water distribution capabilities.

It is a further object of exemplary embodiments to provide a water distribution system and method for expanding water distribution capabilities.

It is a further object of exemplary embodiments to provide a water distribution arrangement including water distribution manifolds and lines employing nonthreaded connections, which can be permanently enclosed within a wall or floor of a building structure.

It is a further object of exemplary embodiments to provide water manifolds that are usable with a variety of fluid connectors.

It is a further object of exemplary embodiments to provide water manifolds and systems for use with water based fluids.

It is a further object to provide manifolds which can be used with fluids or gases, such as natural gas lines to deliver gas to different locations within a building.

It is a further object of exemplary embodiments to provide methods of making water distribution systems that are operative to distribute water to devices that receive water within a building.

Further objects of exemplary embodiments will be made apparent in the following detailed description of exemplary embodiments and the appended claims.

The foregoing objects are accomplished in an exemplary embodiment by a water distribution arrangement that includes at least one manifold comprised of a one-piece unitary molded chlorinated polyvinyl chloride (CPVC) body. CPVC compositions are the most preferred plastic for making the manifolds and fittings of this invention because of CPVC's ability to handle both hot and cold water and its ability to be solvent cemented to itself. CPVC compositions comprise CPVC resin together with several other additives, such as heat stabilizers, impact modifiers, process aids, coloring pigments, and the like. The CPVC compositions comprise at least 50 weight percent CPVC resin, preferably at least 65 weight percent, and more preferably at least 75 weight percent. CPVC compositions are available commercially from several suppliers, such as Lubrizol Advanced Materials, Inc., Kaneka and Georgia Gulf. The most preferred CPVC composition is known as TempRite® 88065-290 from Lubrizol Advanced Materials, Inc. For low temperature applications, such as cold water, other plastics could be used to make the manifold. Examples of these other plastics are PVC and ABS, which are both solvent cementable, and could be used in cold water applications. For purposes of this disclosure, such a manifold is alternatively referred to as a distributor. The exemplary manifold includes an internal chamber. The chamber defines an interior volume or area of the manifold. In an exemplary embodiment, the manifold extends linearly along an axis. A liquid entry port is in fluid communication with the interior volume, and is capable of being connected to a water supply line or other source of pressurized water.

An exemplary manifold further includes at least two liquid outlet ports, which are alternatively referred to herein as sockets. Each socket is configured to have a fitting insert positioned and cemented therein in fluid tight relation. In the exemplary embodiment, fitting inserts may each have one of the variety of connectors thereon, to which water distribution conduits may be operatively connected. Such water distribution conduits may be provided for distributing water from the manifold through the conduits to devices which receive water within the building.

In an exemplary embodiment, the manifold further includes an extension conduit portion. The extension conduit portion extends on an axial end of the manifold opposite the entry port. The extension conduit portion is in fluid communication with the interior area of the manifold. The extension conduit portion includes an extension opening thereon. The exemplary extension conduit portion is configured so that it can be operatively connected with an entry port of a similar further manifold. The further manifold may be configured with the sockets thereon in aligned relation with the sockets on the first manifold. Alternatively, the further manifold may be connected so it is angularly disposed relative to the first manifold, so that the sockets and the fluid connectors on the further manifold are angularly disposed from those on the first manifold. This can facilitate making more suitable conduit connections to the further manifold.

In the exemplary embodiment, the extension conduit portion on a manifold is configured so that when it is not to be connected to a further manifold or other conduit, the extension portion may be capped with a fluid cap. This may be done by cementing the cap in place to fluidly close the extension opening. At a later time when there is a need to expand or change the configuration of the system, the cap may be separated from the manifold. After this is done, there is sufficient remaining axial length of the extension conduit portion so that a further manifold may be engaged therewith. As a result, the water distribution system may be expanded or modified so as to accommodate additional connections to additional or different devices that receive water within the building.

In the exemplary embodiment, each fitting insert includes a plug portion. The plug portion is comprised of CPVC material and is sized for insertion in a socket, wherein it can be cemented in fixed fluid tight connection with the manifold. Further in an exemplary embodiment, each fitting insert includes a water line connector which is adapted for connection to a suitable fitting or other fluid conduit. In exemplary embodiments, the water line connectors may include a metallic fitting, such as a machined stainless steel or brass barbed fitting. Such fittings may be suitable for connection to flexible conduits. These may include, for example, crosslinked polyethlene (PEX) flexible conduits. Of course, other types of rigid or flexible conduits may be used.

In other exemplary embodiments, fitting inserts may include integral valve structures which enable selectively opening and closing water flow into a connected conduit. Alternatively or in addition, other fitting inserts may provide threaded connections to fluid conduits. Further in an exemplary embodiment, the sockets of the manifold may be sized to accept therein standard size plastic conduits, such as rigid CPVC pipe, in cemented, fluid tight relation. Of course these approaches are exemplary, and other embodiments may be used.

In further exemplary embodiments, a heating system for a building may include an exemplary manifold substantially as described above. The manifold may be connected to a supply of a water based heat transfer fluid. For purposes of this disclosure, water based fluids will be referred to as water. The manifold is in fluid communication through appropriate conduits with devices that receive the hot, heated water within the building, such as radiators. Each radiator may have a liquid inlet and a liquid outlet. Each liquid inlet of a radiator is connected to a conduit that is operatively connected to the manifold. Further, the outlets of such radiators may be connected through suitable manifolds or otherwise to one or more collection chambers. Such collection chambers may include a manifold having sockets and fitting inserts so as to receive cooled water that is returned from the radiators.

An exemplary embodiment of a manifold may be manufactured by molding CPVC into a unitary generally closed structure which defines an interior volume. A liquid entry port is provided to the interior volume, and at least two outlet ports or sockets are in operative fluid connection with the interior volume. In the exemplary embodiment, the manifold is formed to include an extension conduit portion which is axially disposed on the manifold from the liquid entry port. Exemplary manifolds may include extension conduit portions of the type previously discussed that are capable of being connected to other devices or capped, and then reopened and connected for purposes of expansion. Exemplary sockets on the manifold are configured to accept fitting inserts in cemented relation therein. Such fitting inserts may include inserts of the type previously discussed that include a plug portion and a connector. Such connectors may include barbs or other nonthreaded connectors which are suitable for nonthreaded connections to crosslinked polyethlene fluid conduits or other suitable conduits. In some exemplary embodiments, the barbed connectors may be comprised of metal such as brass or stainless steel, and conform to ASTM F1807.

In further exemplary embodiments, a water distribution system may be made by providing a manifold including a plurality of fitting inserts in the manifold sockets. The fitting inserts may include numerous types of water line connectors and devices. Such fitting inserts may include valves, threaded connectors, or other suitable connectors for connecting conduits to the manifold. Further, exemplary embodiments may also have sockets sized for accepting CPVC pipe of a standard size therein. Of course, in other embodiments, other types of fittings and connectors known to those skilled in the art may be used.

An exemplary embodiment of a method of making a system for the distribution of water within a building includes providing a molded unitary CPVC manifold of the type previously described. The manifold is operatively connected to a pressurized water supply through the entry port thereof. A plurality of fitting inserts are inserted and cemented in the sockets of the manifold. The fitting inserts of an exemplary embodiment may include water line connectors of nonthreaded types. Such connectors may include barbed connectors suitable for connection to PEX pipe through a nonthreaded connection. The PEX pipe may be extended through walls, floors, or other building structures. The PEX pipe extends in operative fluid connection with devices that receive water within the building. Such devices may include, for example, faucets, dishwashers, showers, bathtubs, toilets, lawn sprinkler systems, sprinkler heads, or other suitable device.

In exemplary embodiments, the manifold may be joined in cemented relation to a further manifold, to which additional fluid conduits may be connected. Exemplary manifolds may also include suitable structures to facilitate mounting and support of the manifold by a surrounding structure, such as metal or wood studs commonly found in buildings. The exemplary manifold may be connected to further manifolds or fluid conduits. Alternatively, the manifold may be fluidly capped in the manner previously described. In some exemplary systems, because a water distribution system may be provided without threaded connectors in an area adjacent to the manifold, the manifold and conduit connections thereto may be enclosed within a wall or floor structure within the building.

In some exemplary embodiments, the manifold may be configured to facilitate the expansion or reconfiguration of the water distribution system. This may be done in situations where the manifold includes an extension conduit portion of sufficient length so that the connection to a cap or other structure which originally closes the extension opening may be changed. This may be done by cutting the cap or other structure from the extension conduit portion. The exemplary extension conduit portion is of sufficient length so that even after a cap or other structure has been separated, sufficient axial length of the extension conduit portion remains so that the remaining extension conduit portion can be joined in fluid tight relation to an entry port on a further manifold, conduit or other suitable structure. Joining the existing manifold to a further manifold may provide additional sockets to which fitting inserts and additional fluid conduits may be connected. This capability provides for the further expansion or modification of the water distribution system. Further, such expansion may be done using various types of fitting inserts and connectors suitable for connection to various types of devices and fluid conduits. As a result, fluid conduits may be extended to additional devices that receive water within the building.

Of course, these approaches are exemplary and in other embodiments other approaches may be used.

### BRIEF DESCRIPTION OF DRAWINGS

FIG. 1a is an exploded perspective view of an exemplary embodiment of a manifold and a plurality of different types of fitting inserts.

FIG. 1b is a perspective view of an exemplary embodiment with a nonthreaded connector on a manifold.

FIG. 2a is an exploded perspective view of an exemplary manifold including a fluid cap.

FIG. 2b is a cross sectional view of the manifold along line 2b-2b in FIG. 2a.

FIG. 3 is an exploded perspective view of an exemplary manifold extension.

FIG. 4 is an exploded perspective view of an alternative manifold and mounting structure.

FIG. 5 is a schematic elevation view of exemplary joined manifolds and fluid conduits.

FIG. 6 is an exploded isometric view showing a fluid conduit and cap.

FIG. 7 is a cross sectional view of an exemplary portion of a manifold, showing a fluid entry port in cemented engagement with a fluid conduit.

FIG. 8 is a schematic view of the further exemplary embodiment of a water distribution system, configured for providing water for heating an area within a building.

FIG. 9 is a top plan view of an alternative exemplary manifold.

FIG. 10 is a cross sectional view of the manifold shown in FIG. 9, taken along line 10-10.

FIG. 11 is a cross-sectional view of the manifold shown in FIG. 9, taken along line 11-11.

FIG. 12 is a perspective view of the manifold shown in FIG. 9.

FIG. 13 is a top plan view of an alternative exemplary manifold extension.

FIG. 14 is a perspective view of the manifold extension shown in FIG. 13.

FIG. 15 is a top plan view of an alternative manifold of an exemplary embodiment.

FIG. 16 is a sectional view of the manifold shown in FIG. 15, taken along 16-16.

FIG. 17 is a cross-sectional view of the manifold shown in FIG. 15, taken along line 17-17.

FIG. 18 is an end view of the exemplary manifold shown in FIG. 15.

FIG. 19 is an isometric view of a portion of an exemplary water distribution system, showing two manifolds joined together so that the fitting inserts extend outward at an angle relative to one another.

FIG. 20 is an isometric view representing how an exemplary manifold which has been closed with a fluid cap may have the cap separated therefrom, and the water distribution system expanded by engagement thereafter with a further manifold.

### DETAILED DESCRIPTION OF EXEMPLARY EMBODIMENTS

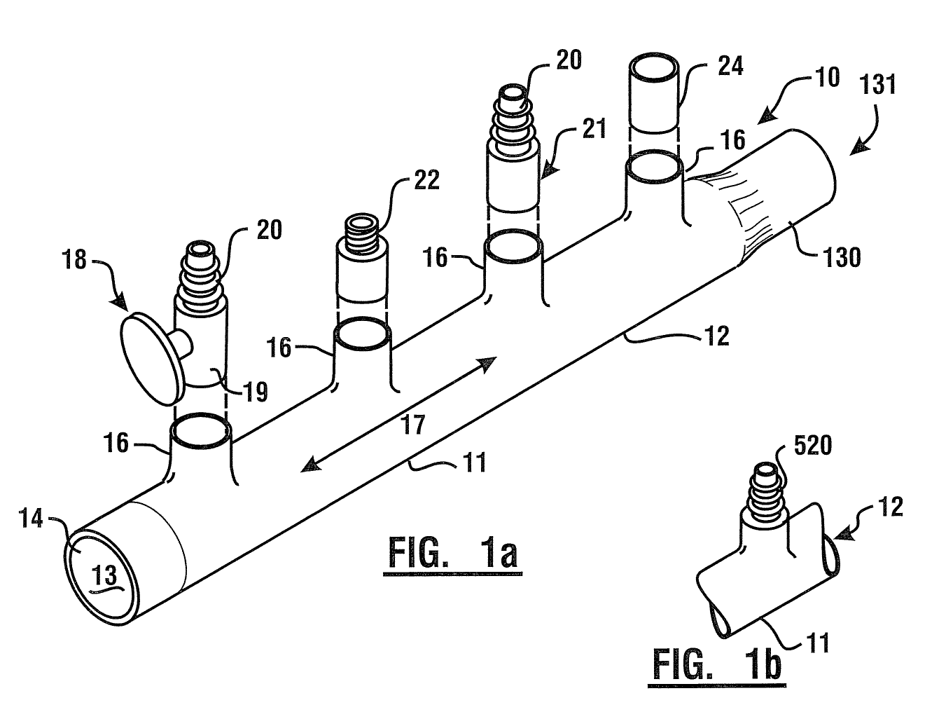

Referring now to the drawings, and particularly to FIG. 1a, there is shown therein a perspective view of an exemplary manifold system 10. In this exemplary embodiment, a manifold or distributor 12 is comprised of molded plastic material. In an exemplary embodiment, the manifold is comprised of a unitary molded CPVC manifold. Of course, in other embodiments, other materials may be used. The manifold bounds a chamber 11 which defines an interior volume 13 of the manifold. The exemplary manifold further includes an entry port 14 and a plurality of liquid outlet ports 16, which are alternatively referred to herein as sockets. In an exemplary embodiment, the entry port may be configured to accept a standard copper tube size (CTS) outside diameter conduit therein. For example, in an exemplary embodiment, the entry port 14 may be configured in the manner of a molded one inch CTS female coupling.

In the exemplary embodiment, the sockets 16 may be sized to accept standard CTS sized fluid conduits therein. In the exemplary embodiment, the entry port and the sockets are adapted to have fluid conduits inserted and engaged to the manifold in cemented fluid tight relation. Of course this approach is exemplary, and in other embodiments other approaches may be used. Another approach would be to have outlet port 16 sized to be a socket port or pipe spigot port. The exemplary embodiment shown in FIG. 1a shows outlet port 16 being sized to accept the fitting insert 21 within the port 16. It is contemplated that the port 16 could also be sized such that fitting insert 21 would fit over port 16. In this alternative embodiment, port 16 would be a socket port or pipe spigot port. The term “fitting insert” is intended to mean that the fitting insert 21 may fit inside port 16 or over port 16 such that port 16 is cemented to the inside of fitting 21.

In an exemplary embodiment, the manifold 12 is of generally cylindrical construction in cross section, and extends along a central axis generally indicated 17. The entry port 14 is positioned at a first axial end of the manifold. Further, in the exemplary embodiment, an extension conduit portion 130 is disposed at an axial end of the manifold disposed away from the liquid entry port. As discussed later in detail, the extension conduit portion of an exemplary embodiment includes an extension opening 131 to the interior of the manifold.

In the exemplary embodiment, the sockets 16 are disposed axially and in aligned relation on the manifold body. Also, the sockets are configured to extend radially outward relative to the axis. In the exemplary embodiment, all of the sockets 16 extend outward in a common radial direction. This may be useful for purposes later discussed, in terms of providing a common orientation for fluid conduits that are attached to the manifold. Of course this approach is exemplary, and in other embodiments, other arrangements in which the sockets have different configurations and orientations relative to one another on a given manifold may be used. Further, in the exemplary embodiment, each of the sockets on the manifold are of the same size. In alternative embodiments, different sized sockets may be provided on a single manifold.

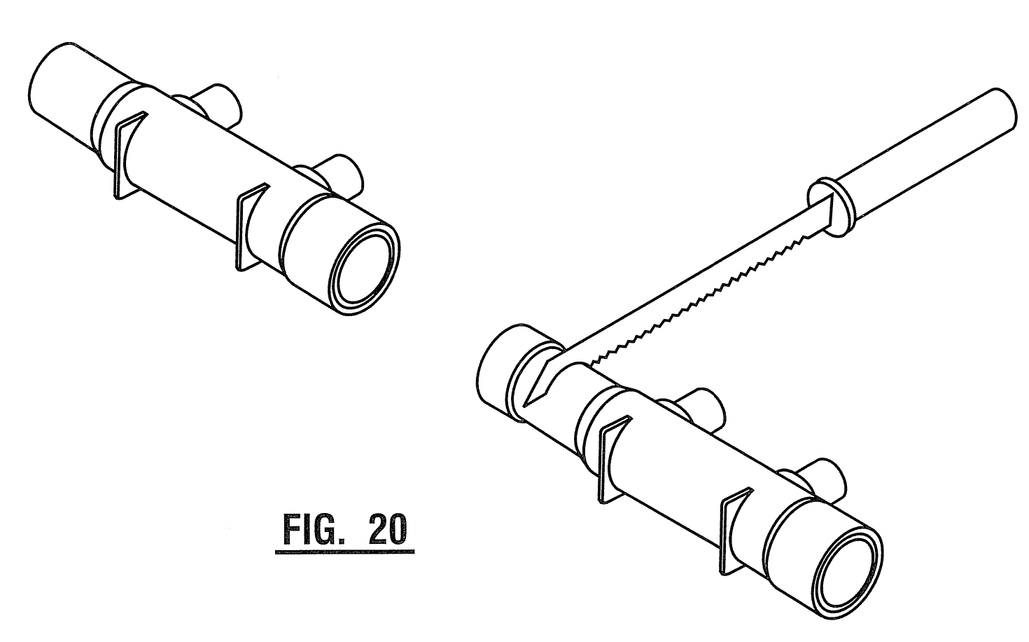

The exemplary manifold 12 may be suitable for use in a system that distributes potable water within a building. For an exemplary residential building, a manifold system may be required that provides for twelve lines for delivering cold water to devices that receive water in the building. As each exemplary manifold includes four sockets, a suitable distributor providing twelve connections for fluid conduits that carry cold water may be provided by joining three such manifolds together. This may be done, for example, by joining the extension conduit portion 130 and a fluid entry port of a further manifold in engaged cemented relation, such as, for example, as shown in FIG. 19. The joining of three manifolds of the type shown in FIG. 1a can provide connections for twelve such fluid conduits. Alternatively, a water distribution system may include connecting manifolds in other ways through suitable conduits. This may provide for connecting fluid conduits to local manifolds at various convenient disposed locations within the building.

Similar assemblies and arrangements of manifolds may be provided for the distribution of hot water within the building. For example, if a water distribution system requires eight fluid conduits to deliver hot water, two manifolds of the type shown in FIG. 1a may be joined together in cemented relation. Alternatively, such manifolds may be fluidly connected through other piping so as to provide connectors for fluid conduits at disposed locations within the building.

As can be appreciated from FIG. 19, the exemplary manifolds may be joined in ways that provide for the sockets to be linearly aligned on each of the manifolds. This may facilitate connecting fluid conduits thereto. For example, all the fluid conduits can connect to the manifolds from a common direction. Alternatively, the sockets on joined manifolds in cross section may be disposed angularly relative one another. This may be done to facilitate connecting to fluid conduits coining off the manifold in various directions, as may be desirable for positioning the sockets so they extend in the directions in which the fluid conduits run away from the manifold in the building.

In some exemplary embodiments, the manifolds may have molded thereon a plurality of positioning marks which are indicated 15 in FIG. 19. In an exemplary embodiment, the positioning marks comprise a plurality of marks that extend on an external surface of a manifold. The positions of the marks are angularly disposed from one another. In an exemplary embodiment the positioning marks are spaced at 90 degree intervals, and one of the positioning marks is linearly aligned with the sockets. The positioning marks may be used to facilitate assembling manifold components or other items in a desired orientation, by aligning the positioning marks or other features on adjacent manifolds. Of course these structures and approaches are exemplary, and in other embodiments, other approaches may be used.

In an exemplary embodiment, the manifold sockets are configured to accept therein a plurality of different types of fitting inserts. The fitting inserts may include connectors thereon suitable for connection to a particular type of fluid conduit or fitting to which the fitting insert is to be joined. FIG. 1a shows a sample of a variety of such fitting inserts and conduits which may be connected to an exemplary manifold. In the exemplary embodiment, the sockets are comprised of a plurality of commonly sized, slightly inwardly tapered, fluid ports. The fitting inserts are adapted to be inserted therein and engaged with the manifold in cemented fluid tight relation. For example, a fitting insert 18 may include a shutoff valve which has attached thereto a nonthreaded barb-type connector 20. The exemplary fitting insert 18 includes a plug portion 19. The plug portion is configured to extend in any of the sockets and be engaged therein in cemented relation. In the exemplary embodiment, the plug portion is comprised of CPVC material. This facilitates cemented engagement with the manifold. The shut off valve may include a suitable flow controlling structure such as a rotatable ball or other valve element. Of course in other embodiments, other arrangements may be used.

A further fitting insert 21 includes a plug portion and a fitting barb 20. Fitting insert 21 has a plug portion that is configured to be inserted and cemented in any of the sockets on the exemplary manifold. A further fitting insert 22 includes a threaded water line connector thereon. Such a water line connector may be suitable for connection to a mating threaded type fluid connector. In exemplary embodiments, the barbs or threaded connectors may be comprised of metal. This may include, for example, brass, copper or stainless steel. Such water line connectors may be molded in embedded connection with the CPVC plug portion. Of course this approach is exemplary, and in other embodiments, other approaches may be used.

Further in the exemplary embodiment, each of the sockets is sized to accept a standard CTS size CPVC plastic fluid conduit therein. This is represented by conduit segment or nipple 24, shown in FIG. 1a. Such a conduit or pipe segment may be joined to the manifold by being inserted and engaged in cemented relation with the manifold. In the exemplary embodiment, each of the sockets on a manifold may be engaged with the same type of fitting insert, or alternatively each may be engaged with a different type of fitting insert or fluid conduit.

In some embodiments, it may be particularly useful in making a water distribution system for operation within a building to employ nonthreaded connectors. Some embodiments may include connectors with external clamps or crimp rings. Some nonthreaded connectors may be of the barbed fitting type which are adapted to conform with ASTM F1807. Such nonthreaded connectors may be particularly useful for engaging crosslinked polyethlene (PEX) fluid conduits. As such, the manifolds may be fluidly connected to PEX conduits which can be extended to the various devices that receive water within the building. Such PEX conduits may be connected to the manifold and extended to such devices without the need for threaded connectors within walls or floors of the building. In this way, a water delivery system may be provided which meets jurisdictional requirements for avoiding threaded connectors within such walls or floors. Of course these approaches are exemplary, and in other embodiments, other approaches may be used.

In exemplary embodiments, the fitting inserts including selected water line connectors are attached to the manifold by inserting them in the sockets and securing them therein with solvent cement or other type of adhesive. Solvent cements normally contain the same type of polymer as is used in the fitting, with the polymer dissolved in one or more solvents. Solvent cements for various plastics are readily available from local hardware and plumbing supply stores. In some exemplary embodiments, tetrahydrofuran-based solvent cements are satisfactory. Of course in other embodiments, other approaches may be used. In addition, alternative embodiments may include having the manifold formed with the connector molded directly therein, or as a part thereof. This is represented by barbed connector 520, which is shown in FIG. 1b. Thus, for example, when the type of water line connector that will be employed in a given system is known in advance, it may be possible in some embodiments to have the particular connectors be included in the manifold at the time that the manifold is manufactured. This approach may find particular utility for systems of a given type where it is desired to avoid threaded connections throughout the system. As a result, the nonthreaded water line connectors on manifolds may be engaged with a water lines such as PEX conduits in a manner that enables the manifold to be permanently covered within the walls or floors of a building. Likewise, avoiding threaded connectors in the water lines that are operatively connected with the devices that receive water, so as to avoid such threaded connectors within the walls or floors of the building, facilitates the installation thereof.

It should also be understood that exemplary embodiments of a water distribution system may be configured so as to minimize costs. Such costs may be minimized by providing a fluid connection between a manifold and a water line, such as a flexible PEX line. Avoiding intermediate valving as well as threaded connections between the manifold and the water line reduces material and installation cost. Thus, for example, in some embodiments, a single valve can be installed fluidly between the pressurized water supply and the entry port of the manifold. Such a single valve may enable shutting off the supply of water to a plurality of sockets and to the devices that are operatively connected thereto. Further, the devices that receive water within the building may include valves or other suitable flow control devices adjacent thereto or thereon for purposes of being able to shut off water selectively to the particular device. As can be appreciated, in such arrangements where a nonthreaded connection can be made at the manifold, a generally continuous run of flexible PEX pipe can be extended to the area adjacent to a particular device that receives water. This provides for decreased cost, as well as reducing the risk of leaks as the result of intermediate fitting joints and the like. Of course these approaches are exemplary, and in other embodiments, other approaches may be used. Further, although the components and manifolds described herein may have connections indicated as entry and outlet ports, in some exemplary systems, fluid flow may be in opposite directions from those discussed herein.

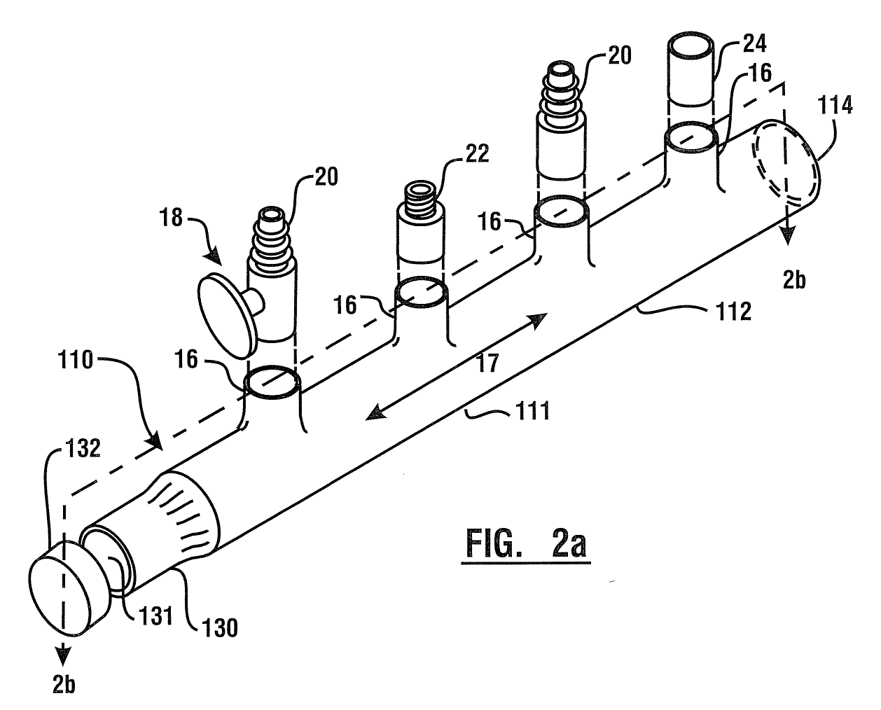

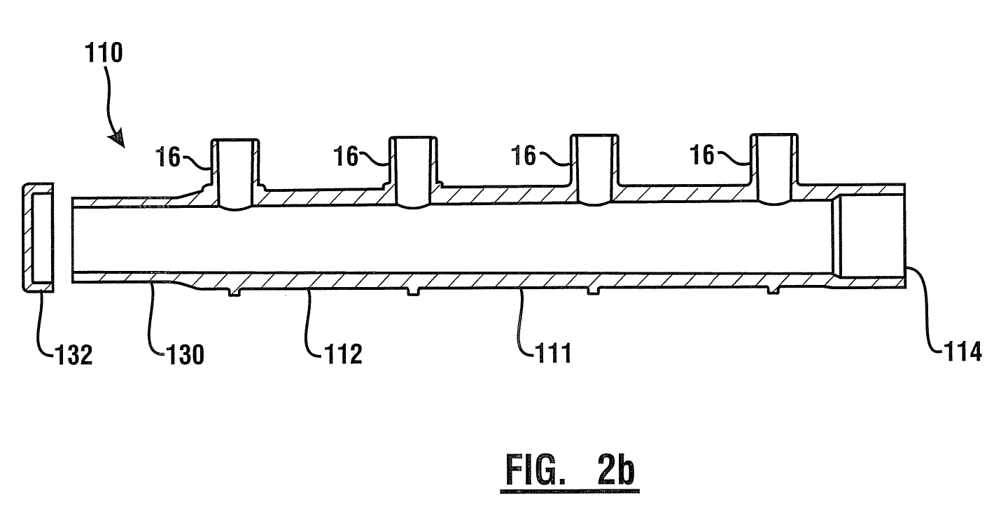

Referring now to FIG. 2a, there is shown a perspective view of an exemplary embodiment of a manifold system generally indicated 110. Manifold system 110 is comprised of a unitary molded CPVC manifold or distributor 112. Manifold 112 of this embodiment is generally similar to manifold 12 previously described. Manifold 112 bounds a chamber 111 which has an interior volume. An entry port 114 is positioned at a first axial end of the manifold. The manifold further includes a plurality of liquid outlet ports 16 which in this exemplary embodiment are the same configuration as the sockets previously described. Also as indicated in FIG. 2a, sockets 16 have been configured to accept therein fitting inserts and water conduits of the type previously discussed.

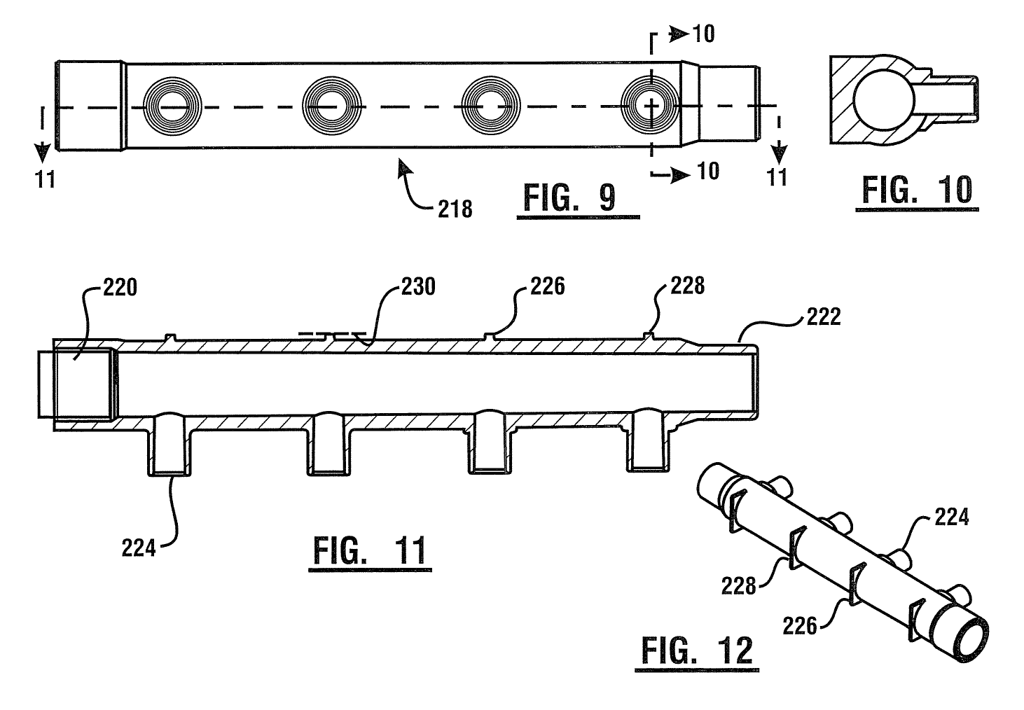

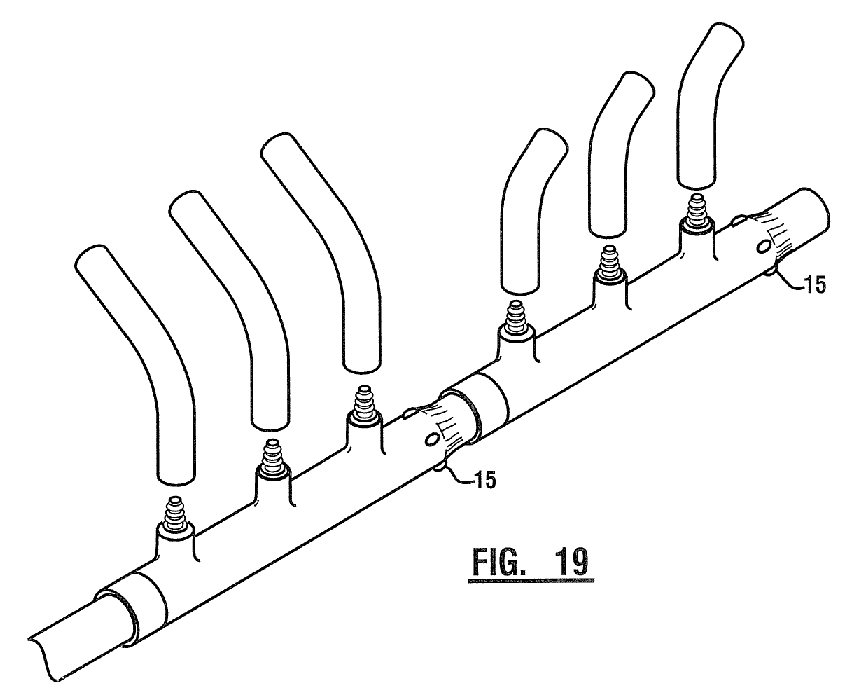

Manifold 112 includes an extension conduit portion 130. Extension conduit portion 130 is disposed at an opposed axial end of the manifold from the entry port. The extension conduit portion includes an extension opening 131 which is in fluid communication with the interior area of the manifold. In the exemplary embodiment, the extension conduit portion is configured so that it can be accepted in an entry port of a further manifold, such has been previously shown in connection with FIG. 19. Further, in some exemplary embodiments, the extension conduit portion may be configured to be accepted in an entry port of other fluid conduits or manifolds, including manifolds and fittings of the type shown in FIGS. 9 through 18. In this way, the extension conduit portion may be attached to other water manifolds and conduits. Further, in still other exemplary embodiments, the extension conduit portion may be sized so as to accept a fluid conduit within the inside diameter thereof. Thus, for example, a plastic pipe might be inserted and cemented within the inside diameter of the opening in the extension conduit portion. Of course all of these approaches are exemplary.

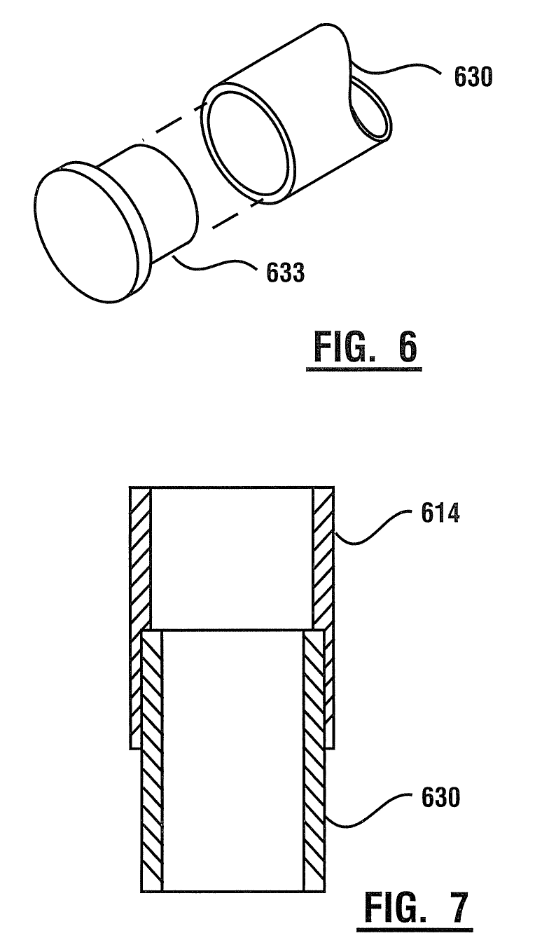

In an exemplary embodiment, the extension conduit portion is of sufficient axial length so that the extension opening 131 may be closed through engagement with a fluid cap 132. In an exemplary embodiment, a recess in the cap 132 has the extension conduit portion inserted therein and secured in cemented relation. This has the effect of generally permanently fluidly closing the extension opening 131. Of course, as will be appreciated by those skilled in the art, the extension conduit portion may have other configurations including being molded so as to have a sealed end. Alternatively, the extension conduit portion may be closed with other types of members, for example an extension plug 633 as shown in FIG. 6.

In some exemplary embodiments, the manifold may be configured to have the extension conduit portion be of sufficient axial length so that even once a cap or plug has been permanently installed thereon, it is still readily possible to modify the manifold to accommodate further expansion of the water distribution system. This might be done, for example, in the manner represented in FIG. 20, by cutting or sawing the extension conduit portion so as to separate the cap from the manifold. Thereafter, in the exemplary embodiment, sufficient axial length of the extension conduit portion still remains so as to enable the extension conduit portion to be accepted within an entry port of a further manifold. Thus, for example, if it is desirable to add additional devices within a building after the original construction, additional manifolds may be added by removing the closure structures from existing manifolds and connecting additional manifolds or other fluid conduit members to the water system. Such features may be particularly useful when it is desired to have additional fixtures such as faucets, toilets, showers, or other devices that receive water, when adding on to residential or commercial construction.

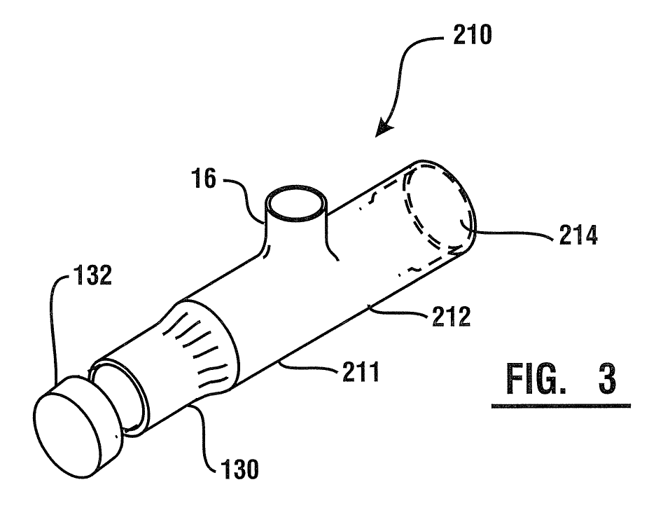

In some circumstances when a system is expanded, it may be desired to add numerous additional water line connectors to the existing system. In other circumstances it may be necessary to add only a single additional water line. This can be done, for example, using the fitting structures shown in FIG. 3 or 13 and 14. The fitting structure 210 shown in FIG. 3 includes a body which in the exemplary embodiment is comprised of a unitary molded plastic structure comprised of CPVC. The structure includes an entry port 214 and an extension conduit portion 130. The extension conduit portion of this exemplary embodiment is sized to have sufficient length so that a cap may installed in cemented relation thereon, and later removed to provide a location for attaching a further manifold. The exemplary fitting also includes a single socket 16 for providing a single additional water line connection thereto. Thus, for example, when it is desired to expand a water system so as to include only one additional water conduit, fitting 210 may be used.

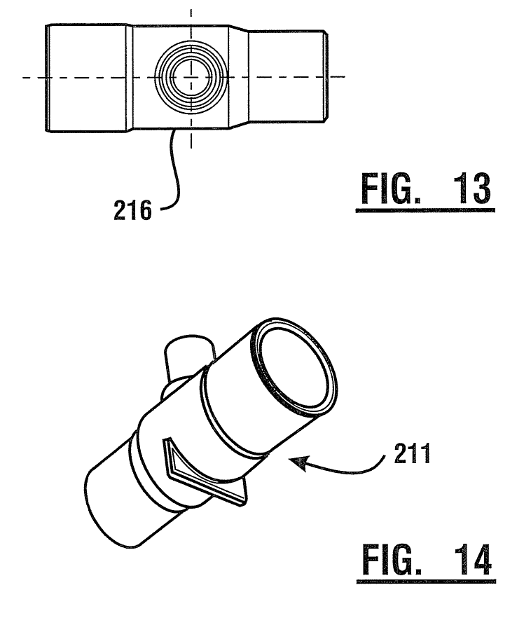

Fitting 216 shown in FIGS. 13 and 14 is generally similar to fitting 210. However, in this particular embodiment, the extension conduit portion is somewhat shorter. A fitting of this type may be used, for example, in situations where the fitting is being connected to another conduit and there is unlikely to be any desire or need to reconfigure the system at the location where fitting 216 is connected in the system. Of course it should be understood that these approaches are exemplary, and in other embodiments, other approaches may be used.

It should further be understood that in exemplary embodiments an extension conduit portion may be configured for being inserted and cemented in an entry port of a further manifold or conduit. This is represented in FIG. 7 by the extension conduit portion 630, which is shown inserted within the internal diameter of a conduit or manifold 614. Thus, for example, the area in which the extension conduit portion 630 is accepted could comprise the entry port of a further manifold. Also, in other exemplary embodiments, the inside diameter of the extension conduit portion may be sized so that a standard size plastic conduit may be inserted and cemented therein. Thus, for example, if it were desired to provide a step down from the extension conduit portion to a smaller pipe size, the extension conduit portion could be so configured. In addition, as can be appreciated, when the extension conduit portion is of sufficient axial length to enable removal of a cap or adjoining fitting therefrom, conduits that have been extended into the internal diameter of the extension conduit portion may also be separated by cutting or sawing so as to separate the extension conduit portion and the existing external conduit. In such cases, a further connection of the manifold may then be made to a further manifold, either by inserting the remaining extension conduit portion within the inside diameter of a further manifold or fitting, or by inserting the further conduit into the inside diameter of the remaining extension conduit portion. Of course it should be understood that these approaches are exemplary, and in other embodiments, other approaches may be used.

FIGS. 9 through 15 show further exemplary embodiments of manifolds that may be used in exemplary water distribution systems. Manifold 218 shown in FIGS. 9 through 12 includes an entry port 220 and an axially disposed extension conduit portion 222. A plurality of axially aligned outlet ports or sockets 224 extend in the manifold and are configured to accept fitting inserts of the types previously described.

In this exemplary embodiment, manifold 218 includes a plurality of ribs 226. Ribs 226 in this exemplary embodiment in cross section extend radially outward on the manifold. Ribs 226 in this exemplary embodiment are angularly disposed from the sockets 224, and in this configuration are radially directly opposed therefrom. Each of ribs 226 terminates radially outward in a flat face 228. Each flat face on the manifold extends in a common plane 230. The termination of the ribs at a common plane facilitates supporting the manifold against a support such as a stud or beam within a building. This may be done, for example, using suitable clamping or other structures that hold the manifold with the ribs in abutting relation with the support. In this exemplary embodiment, the ribs are diametrically opposed of each of the sockets, which helps to provide sufficient rigidity and resistance to deformation when mounted so as to minimize the risk of the manifold being deformed by clamping structures. Of course it should be understood that these approaches are exemplary, and in other embodiments, other approaches may be used.

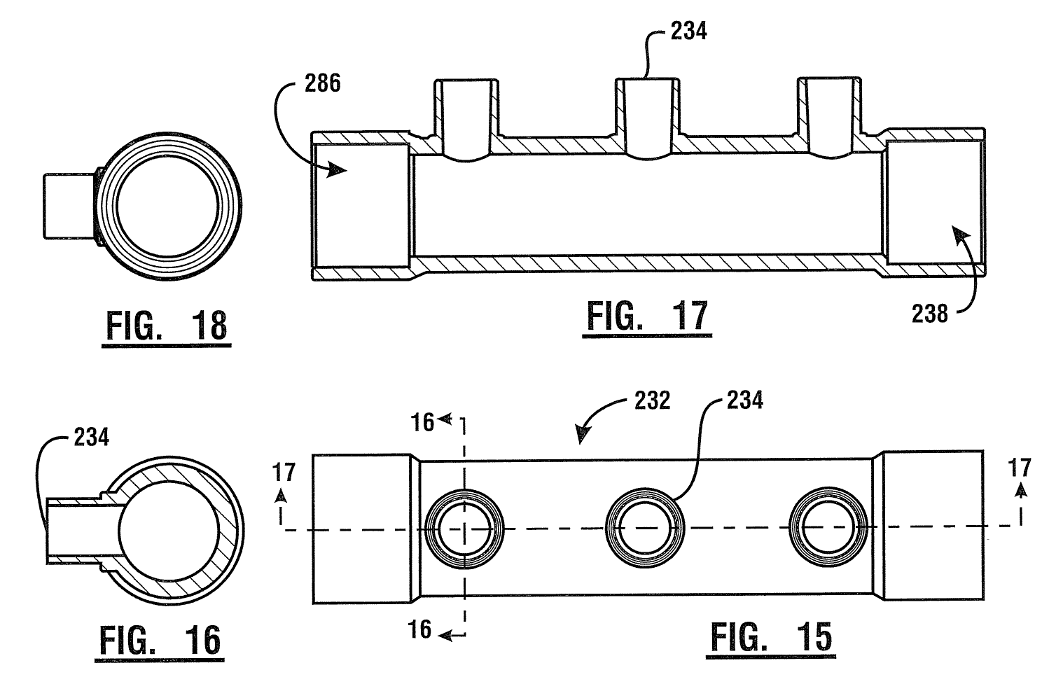

FIGS. 15 through 18 show a further exemplary manifold 232. Manifold 232 includes a plurality of sockets 234. In the exemplary embodiment, sockets 234 may be of similar size and configuration to sockets 16 previously discussed. Of course it should be understood that in other embodiments, other approaches may be used.

In the exemplary embodiment of manifold 232, the manifold includes female coupling ports 236 and 238 at each axial end of the manifold. This enables the exemplary manifold 232 to accept a male connection in inserted and cemented relation at each end thereof. This may be done to facilitate various types of water distribution systems as may be necessary within various types of building structures.

Of course it should be understood that the manifold and fitting insert structure shown are exemplary, and in other embodiments, other structures and configurations may be used. However, it should be appreciated that these exemplary embodiments include certain aspects which may prove beneficial. These include, for example, the fact that the exemplary manifolds do not include intermediate gaskets or other seal structures that may eventually result in leak points. In addition, the exemplary embodiments are configured so as to be usable in connection with nonthreaded connections, which reduce the risk of leaks as well as reduce costs. The ability to use suitable materials such as CPVC and connections which are produced through the use of solvent cement further facilitate rapid and inexpensive connection of conduits, and minimize the risk of leakage. Further, the ability of the exemplary embodiments to connect to numerous different types of fluid conduit structures and devices, as well as the ability to reconfigure the fluid conduit system, may prove beneficial. Of course it should be understood that these structures and benefits are exemplary, and in other embodiments, other approaches may be used.

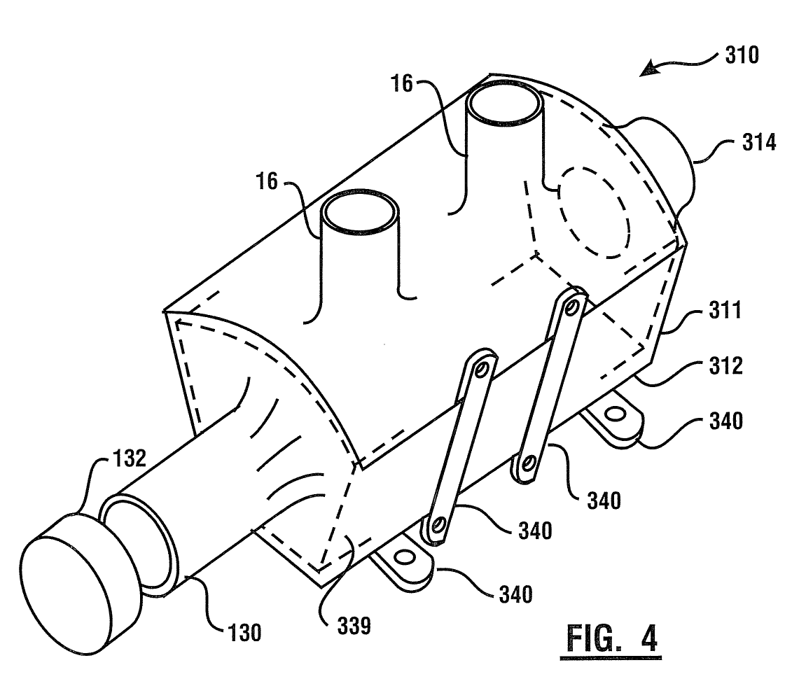

FIG. 4 shows a perspective view of an alternative manifold 310 of an exemplary embodiment. This exemplary manifold has a body 312 comprised of molded unitary CVPC construction. The manifold has a chamber 311 which defines an interior area or volume. The manifold includes an entry port 314 and a plurality of outlet ports comprised of sockets 16.

This exemplary manifold 312 further includes an extension conduit portion 130. The extension conduit portion 130 is configured so that it may be fluidly sealed, such as through cemented engagement with a cap 132. In this exemplary embodiment, the manifold 312 is molded so as to include substantially flat outside surfaces which are alternatively referred to as walls 339. This feature of this exemplary embodiment may provide advantages in facilitating the mounting of the manifold structure in connection with the common building structures. This may include, for example, mounting the manifold to a flat surface of a wall or stud, as may be found in many buildings. Such an assembly may prove more stable in some embodiments for securing the manifold against such flat surfaces. Also, as shown in FIG. 4, in some exemplary embodiments integral mounting structures 340 may be included on or in connection with the manifold so as to facilitate the securing of the manifold structure to an adjacent clamp or other building structure. Of course it should be understood that these approaches are exemplary, and in other embodiments, other approaches may be used.

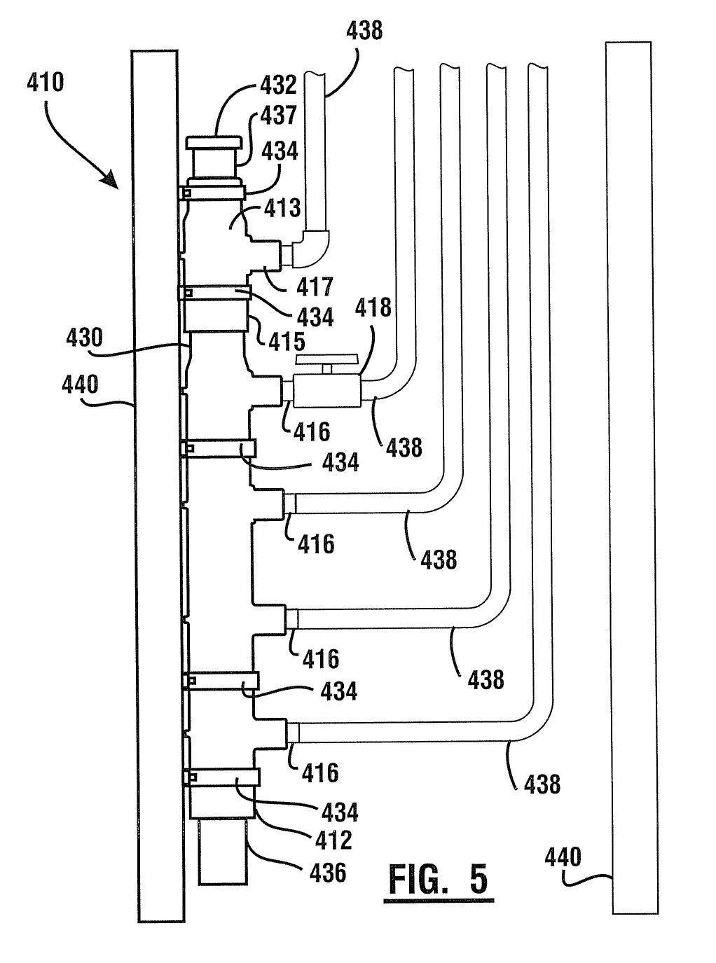

FIG. 5 shows a schematic view of a manifold system generally indicated 410 of a further alternative embodiment. A first manifold 412 is shown mounted in supporting connection with a frame 440 such as a wall stud or other supporting structure. The mounting can be done through one or more supporting straps 434, which are fastened into operative connection with the frame 440 with screws, nails or other suitable fasteners.

Water distribution conduits 438 such as CPVC pipe or PEX pipe are fluidly connected to the water line connectors on the inserts which are installed in the sockets on the manifold. Such inserts are generally indicated 416. The water distribution conduits 438 extend in operative connection with devices that receive water within the building. For example, in some embodiments as previously discussed, the water conduits may each comprise a flexible water line that extends in generally continuous relation from the connector at the manifold, through the building structures and into an area adjacent to the particular water receiving device.

The supply conduit 436 provides an operative fluid connection between the manifold system 410 and a source of pressurized water. The source of pressurized water is therefore in fluid connection with all the fluid conduits 438 that are connected to manifold 412. Further, manifold 412 includes an extension conduit portion 430. Extension conduit portion 430 is in operative connection with an entry port 415 and a further fitting or manifold 413. As shown in FIG. 5, manifold 413 includes a further extension conduit portion 437. Extension conduit portion 437 is shown closed by cemented engagement with a cap 432. However, it should be understood that in other embodiments, the extension conduit portion may be attached to a further manifold or other conduit structure.

Manifold 413 further includes an outlet port 417. Outlet port 417 in an exemplary embodiment is configured similar to the sockets 16, previously discussed, and is operative to accept therein a fitting insert or other suitable water distribution conduit. As shown in FIG. 5, outlet port 417 is connected through a generally rigid plastic pipe connection, whereas outlet ports and fitting inserts 416 on manifold 412 are connected to flexible water line conduits. Further, as represented in FIG. 5, at least some of the water line conduits may include an intermediate valve 418 between the manifold and the conduit. Such valves may be integrated with the fitting inserts or separate components. Likewise as discussed, although generally nonthreaded connections have been used for connecting the fluid conduits and the manifold, in other embodiments threaded connectors and fittings may be used.

In the exemplary embodiment shown in FIG. 5, the fluid conduits carry water to various devices within the building that receive water. These may include, for example, faucets, toilets, hot water tanks, showers, sprinkler heads, or other devices.

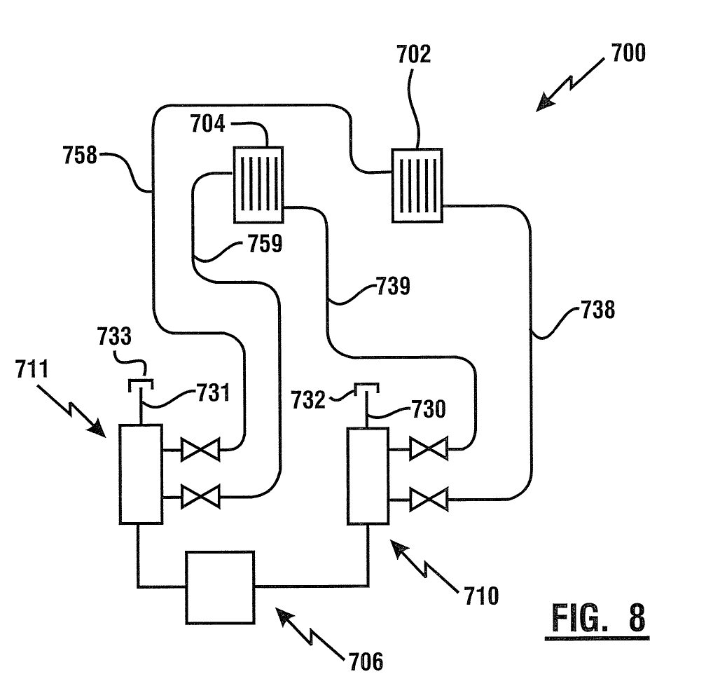

A further exemplary embodiment showing a water distribution system which both delivers water to and receives water from devices in a building is shown in FIG. 8. FIG. 8 schematically shows a heating system 700 designed to provide a heat transfer fluid, such as, for example, a water based heat transfer fluid, for circulation within the system. The exemplary system includes one or more heat exchangers which are alternatively referred to as radiators 702 and 704. A supply of hot fluid 706 such as a water heating device provides pressurized hot water for delivery to a first manifold 710. The manifold 710 may be of a type previously described which delivers the hot water into conduits 738 and 739. Conduits 738 and 739 may be connected through suitable fluid connectors of the types previously described. Valving may also be included in connection with the lines as schematically indicated in FIG. 8. Further, in exemplary embodiments, the manifold 710 may include an extension conduit portion of the types previously described and which is indicated 730. The extension conduit portion as shown in FIG. 8 is closed with a fluid cap 732 or other suitable structure.

In the system represented in FIG. 8, hot fluid that is passed through radiators 702 and 704 is returned to a collector manifold generally indicated 711. The returning fluid passes through conduits 758 and 759. Collector 711 may be comprised of a further manifold of the types previously described. The manifold may also include an extension conduit portion schematically indicated 731, which is closed by a fluid cap schematically indicated 733. The cooled returning fluid in manifold 711 is then returned to the heater 706, where it is again heated for cycling through the system.

As can be appreciated, the use of manifolds of the type of the exemplary embodiments shown herein facilitates the efficient and fluid tight connection of the distribution and collection conduits of the system. Further, the use of manifolds which provide for fast and efficient assembly help to provide economical systems. Further, the ability to reconfigure and expand such systems in the future also makes it more economical when building expansion or renovation is done at a later date.

Thus, the features, structures, characteristics, and methods associated with the embodiments previously described achieve desirable results, eliminate difficulties encountered in the use of prior devices, systems, and methods, solve problems, and may attain one of more of the objectives described herein.

The manifolds described in this invention above can be produced using an injection molding process. The injection molding process is well understood by those skilled in the art and will not be described in detail for the sake of brevidity. The process involves heating plastic and injecting the plastic into a mold.

In the foregoing description, certain terms have been used for brevity, clarity and understanding. However, no unnecessary limitations are to be implied therefrom, because such terms are used for descriptive purposes and are intended to be broadly construed. Moreover, the descriptions and illustrations herein are by way of examples, and the invention is not limited to the details shown and described.

In the following claims, any feature described as a means for performing a function shall be construed as encompassing any means known to those skilled in the art to be capable of performing the recited function, and shall not be deemed limited to the structures shown herein or mere equivalent hereof.

Having described the features, discoveries and principles of the invention, the maimer in which it is constructed and operated, and the advantages on useful results attained, the new and useful structures, devices, elements, arrangements, parts, combinations, systems, operations, methods and relationships are set forth in the appended claims.

We claim:

1. Apparatus comprising:
a manifold, wherein the manifold is of unitary molded plastic construction, wherein the manifold includes an entry port, wherein the entry port is configured to be operatively connected to a pressurized water supply,
a plurality of sockets in fluid connection with the entry port through the manifold, wherein each socket is configured to accept in cemented connection a fitting insert, wherein each fitting insert includes a water line connector thereon.

2. The apparatus according to claim 1 wherein the manifold includes an extension conduit portion,
wherein the extension conduit portion includes an extension opening,
wherein the extension opening is in fluid connection with the entry port through the manifold,
wherein the extension conduit portion is configured to be accepted in cemented relation with any of (a) a further entry port of a further manifold, wherein the further entry port has a configuration of the entry port, and (b) a fluid tight cap.

3. The apparatus according to claim 2,
wherein the entry port is disposed on the manifold from the extension opening along an axis,
wherein the plurality of sockets are disposed axially between the entry port and the extension opening,
and wherein each of the sockets extends radially relative to the axis.

4. The apparatus according to claim 3 wherein each of the sockets in cross section extends radially outward in a common radial direction.

5. The apparatus according to claim 4 wherein the manifold further includes a plurality of outward extending ribs, wherein each of the ribs extends radially outward relative to the axis.

6. The apparatus according to claim 5 wherein each of the plurality of ribs is radially disposed on the manifold from each of the sockets.

7. The apparatus according to claim 6 wherein each of the ribs terminates radially outward at a flat face, wherein each of the plurality of flat faces extends in a common plane.

8. The apparatus according to claim 7 wherein each of the ribs extends in a direction radially opposed of at least one of the sockets.

9. The apparatus according to claim 8 wherein each rib extends on the manifold diametrically opposite of a respective socket.

10. The apparatus according to claim 4 wherein the extension conduit portion is configured such that the further entry port of the further manifold may be selectively angularly positioned about the axis of the manifold.

11. The apparatus according to claim 10 wherein the manifold includes a plurality of uniform angularly disposed positioning marks thereon, whereby the positioning marks facilitate angularly positioning the further manifold relative to the manifold.

12. The apparatus according to claim 10 and further comprising:
a first fitting insert,
wherein the first fitting insert includes a first plug portion configured to be inserted and cemented in any of the plurality of sockets,
wherein the first fitting insert includes a first connector configured to operatively engage a flexible water line in fluid tight connection.

13. The apparatus according to claim 12, wherein the first connector comprises a barbed connector configured to connect with a flexible water line comprised of crosslinked polyethylene (PEX).

14. The apparatus according to claim 12 and further comprising:
a second fitting insert, wherein the second fitting insert includes:
a second plug portion configured to be inserted and cemented in any of the plurality of sockets, wherein the second fitting insert further includes a second connector and a shutoff valve, wherein the shutoff valve is positioned operatively intermediate of the second plug portion and the second connector.

15. The apparatus according to claim 14 wherein the second connector includes a nonthreaded connector, wherein the second connector is configured for connection to a flexible water line.

16. The apparatus according to claim 15 wherein the second connector includes a barbed connector configured to connect with a flexible water line comprised of PEX.

17. The apparatus according to claim 14 and further comprising:
a third fitting insert,
wherein the third fitting insert includes a third plug portion configured to be inserted and cemented in any of the plurality of sockets, and a third connector,
wherein the third connector includes a threaded connector.

18. The apparatus according to claim 17 wherein each of the plurality of sockets is configured to accept a standard copper tube size (CTS) plastic conduit in inserted and cemented relation therein.

19. The apparatus according to claim 18 wherein the extension conduit portion is configured to be of sufficient axial length, such that the extension conduit portion can be cut so as to separate a fluid tight cap in engagement therewith from the manifold, and wherein after the fluid tight cap and the manifold have been separated, the extension conduit portion still has sufficient axial length to provide for inserted and cemented fluid tight engagement with a further entry port of a further manifold, wherein the further entry port has a configuration of the entry port.

20. The apparatus according to claim 19 wherein the manifold is comprised of molded chlorinated polyvinyl chloride (CPVC).

21. The apparatus according to claim 20 wherein the first fitting insert includes a first plug portion comprised of CPVC and a first connector comprised of metal.

22. The apparatus according to claim 20 wherein the first, second and third plug portions are each comprised of CPVC.

23. The apparatus according to claim 2 wherein the extension conduit portion is configured to be of sufficient axial length, such that the extension conduit portion can be cut so as to separate a fluid tight cap in engagement therewith from the manifold, and wherein after the fluid tight cap and the manifold have been separated, the extension conduit portion still has sufficient axial length to provide for inserted and cemented fluid tight engagement with a further entry port of a further manifold, wherein the further entry port has a configuration of the entry port.

24. The apparatus according to claim 1 and further comprising a first fitting insert, wherein the first fitting insert comprises a first plug portion, wherein the first plug portion is configured to be inserted and cemented in any of the plurality of sockets, and wherein the first fitting insert includes a first connector configured to operatively engage a flexible water line in fluid tight engagement.

25. The apparatus according to claim 24 wherein each of the manifold and the first plug portion comprises CPVC.

26. The apparatus according to claim 25 wherein each flexible water line is comprised of PEX, and wherein the first connector provides for nonthreaded connection with the flexible water line.

27. The apparatus according to claim 24 wherein each of the plurality of sockets is configured to accept in cemented relation, a CTS plastic conduit.
